(19) United States
(12) Patent Application Publication
(10) Pub. No.: US 2025/0113371 A1
(43) Pub. Date: Apr. 3, 2025

(54) REMOTE UNIT CLUSTER OPTIMIZATION IN A WIRELESS COMMUNICATIONS SYSTEM (WCS)

(71) Applicant: CORNING RESEARCH & DEVELOPMENT CORPORATION, Corning, NY (US)

(72) Inventor: Roni Aharon Shurki, Modiin (IL)

(21) Appl. No.: 18/376,081

(22) Filed: Oct. 3, 2023

(51) Int. Cl. H04W 72/54; H04W 72/044

(52) U.S. Cl. CPC H04W 72/54; H04W 72/046

(57) ABSTRACT

Remote unit cluster optimization in a wireless communications system (WCS) is disclosed. More specifically, the remote unit cluster optimization is supported in a radio access network (RAN) subsystem in the WCS. The RAN subsystem includes multiple remote units (RUs) clusters, each including a set of RUs for providing wireless communications in the respective RU cluster. Herein, a RU control circuit is provided in between a distribution unit (DU) and the RUs to facilitate downlink and uplink communications between the DU and the RUs based on Open-RAN (O-RAN) shared-cell typology. In embodiments disclosed herein, the RU control circuit is configured to perform certain optimization tasks in any of the RU clusters that is deemed underperforming. By performing such RU cluster optimization, it is possible to dynamically improve coverage, power consumption, and/or data throughput in the RU clusters to thereby provide enhanced user experience in the WCS.

### BACKGROUND

This disclosure relates generally to wireless communications systems (WCSs) and related networks, such as Universal Mobile Telecommunications Systems (UMTSs), its offspring Long Term Evolution (LTE) and 5th Generation New Radio (5G-NR) described and being developed by the Third Generation Partnership Project (3GPP), and more particularly to radio access networks (RANs) and user mobile communication devices connecting thereto, including small cell RANs and Open-RANs (O-RANs), implemented in such mobile communications systems.

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communications systems have been provided to transmit and/or distribute communications signals to wireless devices called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of a radio node/base station that transmits communications signals distributed over physical communications medium remote unit forming radio frequency (RF) antenna coverage areas, also referred to as “antenna coverage areas.” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

Operators of mobile systems, such as UMTSs and its offspring including LTE and LTE-Advanced, are increasingly relying on wireless small cell RANs in order to deploy for example indoor voice and data services to enterprises and other customers. Such small cell RANs typically utilize multiple-access technologies capable of supporting communications with multiple users using RF signals and sharing available system resources such as bandwidth and transmit power. Evolved universal terrestrial radio access (E-UTRA) is the radio interface of 3GPP's LTE upgrade path for UMTS mobile networks. In these systems, there are different frequencies where LTE (or E-UTRA) can be used, and in such systems, user mobile communications devices connect to a serving system, which is represented by a cell. In LTE, each cell is produced by a node called eNodeB (eNB). A gNodeB (gNB) is a node in a cellular network that provides connectivity between user equipment (UE) and the evolved packet core (EPC).

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN1-CNN of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The WCS 100 may be configured to operate as a 5G and/or a 5G-NR communications system. In this regard, the radio node 102 can function as a 5G or 5G-NR base station (a.k.a. gNodeB) to service the wireless client devices 106(1)-106(W). Notably, the 5G or 5G-NR wireless communications system may be implemented based on a millimeter-wave (mmWave) spectrum that can make the communications signals 110(1)-110(N) more susceptible to propagation loss and/or interference. As such, it is desirable to radiate the RF beams 120(1)-120(N) via RF beamforming to help mitigate signal propagation loss and/or interference.

The WCS 100 may be further configured to operate based on an Open-RAN (O-RAN) architecture. O-RAN is a standard set forth by the O-RAN Alliance, found at https://www.o-ran.org/. The O-RAN standard specifies multiple options for functional divisions of a cellular base station between physical units and it also specifies the interface between these units. FIGS. 2A and 2B are schematic diagrams providing exemplary illustration of O-RANs 200 and 202, respectively, that are configured according to O-RAN shared-cell topology.

In the O-RANs 200, 202, the functionality of the base station (e.g., gNB, as called in the context of 5G) is divided into three functional units of an O-RAN central unit (O-CU) 204, an O-RAN distribution unit (O-DU) 206, and one or more O-RAN remote units (O-RUs) 208(1)-208(N). These components may run on different hardware platforms and reside at different locations. The O-RUs 208(1)-208(N) include the lowest layers of the base station, and it is the entity that wirelessly transmits and receives signals to user devices. The O-CU 204 includes the highest layers of the base station and is coupled to a “core network” of the cellular service provider. The O-DU 206 includes the middle layers of the base station to provide support for a single cellular service provider (also known as operator or carrier). An F1 interface 210 is connected between the O-CU 204 and the O-DU 206. An eCPRI/O-RAN fronthaul interface 212 connects the O-DU 206 and an O-RUs 208. The F1 interface 210 and eCPRI/O-RAN fronthaul interface 212 use Ethernet protocol for conveying the data in this example. Therefore, Ethernet switches (not shown in FIGS. 2A and 2B) may exist between the O-CU 204 and the O-DU 206, and between the O-DU 206 and the O-RU 208.

Each O-DU 206 can also be coupled to a single or to a cluster of O-RUs 208(1)-208(N) that serve signals of the one or more “cells” of the O-DU 206. A “cell” in this context is a set of signals intended to serve subscriber units (e.g., cellular devices) in a certain area. Multiple O-RUs 208(1)-208(N) are supported in the O-RAN by what is referred to as “Shared-Cell.” Shared Cell is realized by a front-haul multiplexer (FHM) 214, placed between the O-DU 206 and the O-RUs 208(1)-208(N). The FHM 214 de-multiplexes downlink signals from the O-DU 206 to the plurality of O-RUs 208(1)-208(N), and multiplexes uplink signals from the plurality of O-RUs 208(1)-208(N) to the O-DU 206. The FHM 214 can be considered as an O-RU with fronthaul support and additional copy-and-combine function, but lacks the RF front end capability. The O-RAN 200 in FIG. 2A shows the O-RUs 208(1)-208(N) supporting the same cell (#1). The O-RAN 202 in FIG. 2B shows each O-RU 208(1)-208(N) supporting the different cell (#1 . . . #M). In each case of the O-RANs 200, 202 in FIGS. 2A and 2B, and the O-DU 206 provide support for a single cellular service provider to provide cell services to the plurality of O-RUs 208(1)-208(N). However, given that the FHM 214 multiplexes (i.e., sums) the uplink signals received from each of the O-RUs 208(1)-208(N) as part of the same cell to provide to the O-DU 206, any noise that is present in the uplink signals from each of the O-RUs 208(1)-208(N) gets combined into the multiplexed uplink signal provided back to the O-DU 206 thus reducing uplink signal-to-noise ratio (SNR). Gain may not be able to be increased to increase SNR due to gain limitations on the multiplexed uplink signal.

No admission is made that any reference cited herein constitutes prior art. Applicant expressly reserves the right to challenge the accuracy and pertinency of any cited documents.

### SUMMARY

Embodiments disclosed herein include remote unit cluster optimization in a wireless communications system (WCS). More specifically, the remote unit cluster optimization is supported in a radio access network (RAN) subsystem in the WCS. The RAN subsystem includes multiple remote units (RUs) clusters, each including a set of RUs for providing wireless communications in the respective RU cluster. Herein, the RAN system is configured based on Open-RAN (O-RAN) shared-cell typology, in which a RU control circuit is provided in between a distribution unit (DU) and the RUs to act as a front-haul multiplexer (FHM) and facilitate downlink and uplink communications between the DU and the RUs. In embodiments disclosed herein, the RU control circuit is configured to perform certain optimization tasks in any of the RU clusters that is deemed underperforming. In a non-limiting example, such optimization tasks can include muting an underutilized RU(s) in the underperforming RU cluster and/or re-clustering the underutilized RU(s) into a different RU cluster. By performing such RU cluster optimization, it is possible to dynamically improve coverage, power consumption, and/or data throughput in the RU clusters to thereby provide enhanced user experience in the WCS.

One exemplary embodiment of the disclosure relates to an RU control circuit. The RU control circuit includes a plurality of RU interfaces. Each of the plurality of RU interfaces is coupled to one or more RUs in a respective one of a plurality of RU clusters associated with a respective one of a plurality of beam identifications (BEAMIDs). The one or more RUs in each of the plurality of RU clusters are configured to communicate with a respective set of user equipment (UE) based on the respective one of the plurality of BEAMIDs. The RU control circuit also includes a processing circuit. The processing circuit is coupled to the plurality of RU interfaces. The processing circuit is configured to process a link quality measurement collected by the respective set of UE in each of the plurality of RU clusters with respect to the one or more RUs in the respective one of the plurality of RU clusters. The processing circuit is also configured to determine, based on the processed link quality measurement, whether it is necessary to optimize any of the plurality of RU clusters. The processing circuit is also configured to optimize one or more of the plurality of RU clusters in response to determining that it is necessary to optimize the one or more of the plurality of RU clusters.

An additional exemplary embodiment of the disclosure relates to a method for optimizing an RU cluster(s) in a WCS. The method includes processing link quality measurement collected by a respective set of UE in each of a plurality of RU clusters with respect to one or more RUs in the respective one of the plurality of RU clusters. The method also includes determining, based on the processed link quality measurement, whether it is necessary to optimize any of the plurality of RU clusters. The method also includes optimizing one or more of the plurality of RU clusters in response to determining that it is necessary to optimize the one or more of the plurality of RU clusters.

An additional exemplary embodiment of the disclosure relates to a WCS. The WCS includes a centralized services node coupled to a service node. The WCS also includes an O-RAN subsystem. The O-RAN subsystem includes a distribution unit coupled to the centralized services node. The O-RAN subsystem also includes an RU control circuit. The RU control circuit is coupled to the distribution unit. The RU control circuit includes a plurality of RU interfaces each coupled to one or more RUs in a respective one of a plurality of RU clusters associated with a respective one of a plurality of BEAMIDs. The one or more RUs in each of the plurality of RU clusters are configured to communicate with a respective set of UE based on the respective one of the plurality of BEAMIDs. The RU control circuit also includes a processing circuit. The processing circuit is coupled to the plurality of RU interfaces. The processing circuit is configured to process a link quality measurement collected by the respective set of UE in each of the plurality of RU clusters with respect to the one or more RUs in the respective one of the plurality of RU clusters. The processing circuit is also configured to determine, based on the processed link quality measurement, whether it is necessary to optimize any of the plurality of RU clusters. The processing circuit is also configured to optimize one or more of the plurality of RU clusters in response to determining that it is necessary to optimize the one or more of the plurality of RU clusters.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a radio access network (RAN), configured to communicate communications signals with user devices via radio frequency (RF) beamforming;

FIGS. 2A and 2B are schematic diagrams providing exemplary illustrations of Open-RANs (O-RANs) configured according to O-RAN shared-cell topology;

FIGS. 3A-3C are schematic diagrams providing exemplary illustrations of a number of fundamental aspects related to radio frequency (RF) beamforming;

FIG. 4 is a schematic diagram of an exemplary WCS configured according to any of the embodiments disclosed herein to support remote unit cluster optimization;

FIG. 5 is a schematic diagram of an exemplary O-RAN subsystem in the WCS of FIG. 4 that operates based on O-RAN shared-cell topology and configured according to embodiments of the present disclosure to optimize a remote unit (RU) cluster(s);

FIG. 6 is a flowchart of an exemplary process whereby the O-RAN subsystem in FIG. 5 can support remote unit cluster optimization;

FIG. 7 is a schematic diagram of an exemplary remote unit (RU) control circuit, which can be provided in the O-RAN subsystem of FIG. 5 to optimize the RU cluster(s);

FIG. 8 is a schematic diagram of an exemplary RU that can be configured to perform RF beamforming in the RU clusters in FIGS. 6 and 7;

FIGS. 9-11 are flowcharts of exemplary processes that can be employed in the O-RAN subsystem of FIG. 5 to perform specific optimization tasks;

FIG. 12 is a partial schematic cut-away diagram of an exemplary building infrastructure that includes the O-RAN subsystem of FIG. 5 to support remote unit cluster optimization;

FIG. 13 is a schematic diagram of an exemplary mobile telecommunications environment that can include the O-RAN subsystem of FIG. 5 to support remote unit cluster optimization; and

FIG. 14 is a schematic diagram of a representation of an exemplary computer system that can be included in or interfaced with any of the components in a WCS, including but not limited to the O-RAN subsystem of FIG. 5, to support remote unit cluster optimization.

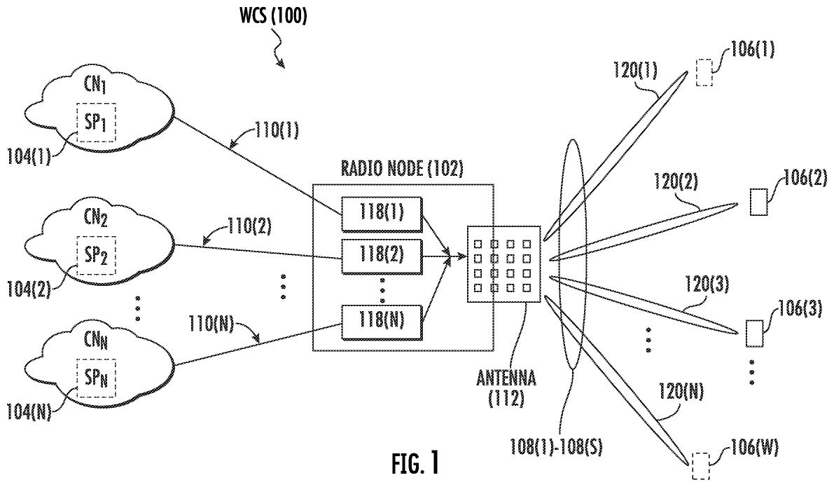

### DETAILED DESCRIPTION

Embodiments disclosed herein include remote unit cluster optimization in a wireless communications system (WCS). More specifically, the remote unit cluster optimization is supported in a radio access network (RAN) subsystem in the WCS. The RAN subsystem includes multiple remote units (RUS) clusters, each including a set of RUs for providing wireless communications in the respective RU cluster. Herein, the RAN system is configured based on Open-RAN (O-RAN) shared-cell typology, in which a RU control circuit is provided in between a distribution unit (DU) and the RUs to act as a front-haul multiplexer (FHM) and facilitate downlink and uplink communications between the DU and the RUs. In embodiments disclosed herein, the RU control circuit is configured to perform certain optimization tasks in any of the RU clusters that is deemed underperforming. In a non-limiting example, such optimization tasks can include muting an underutilized RU(s) in the underperforming RU cluster and/or re-clustering the underutilized RU(s) into a different RU cluster. By performing such RU cluster optimization, it is possible to dynamically improve coverage, power consumption, and/or data throughput in the RU clusters to thereby provide enhanced user experience in the WCS.

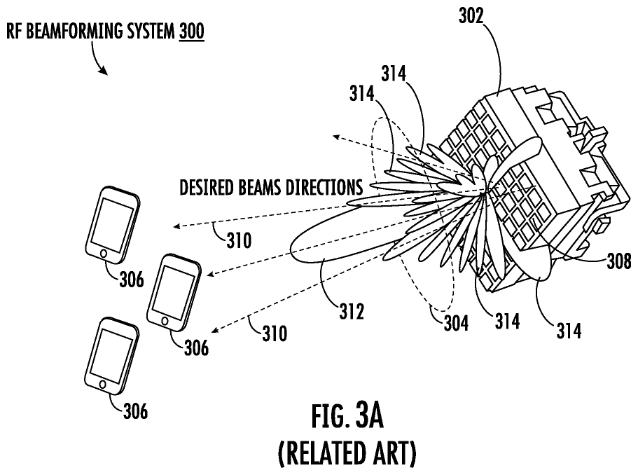

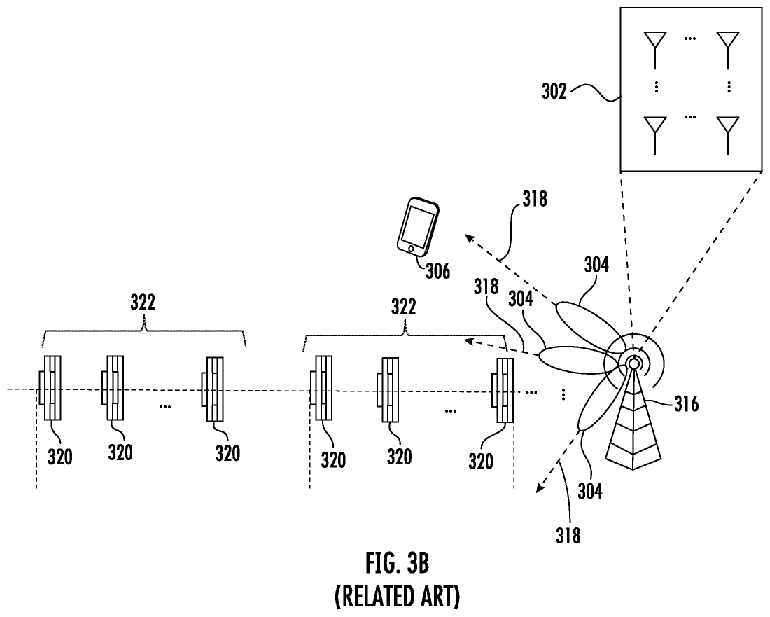

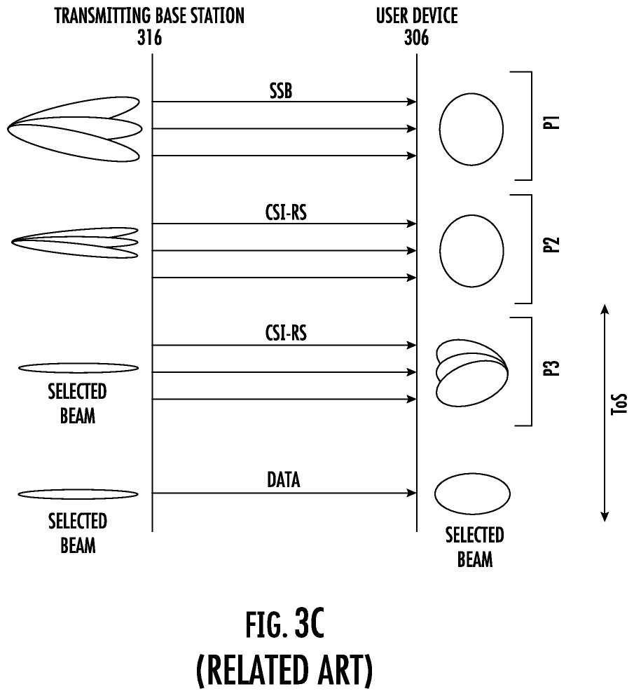

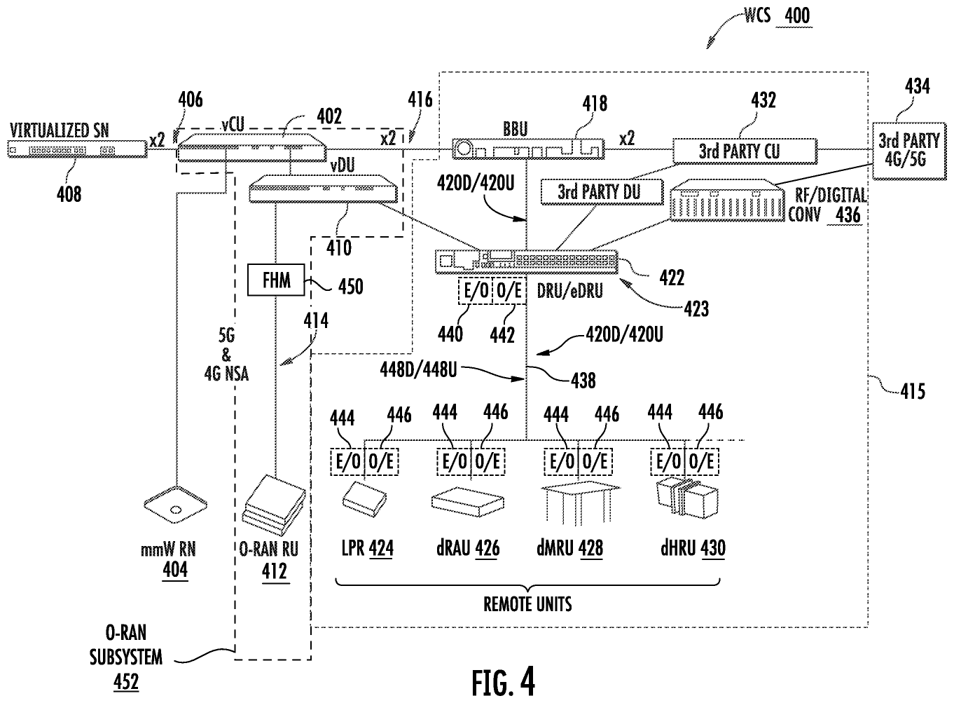

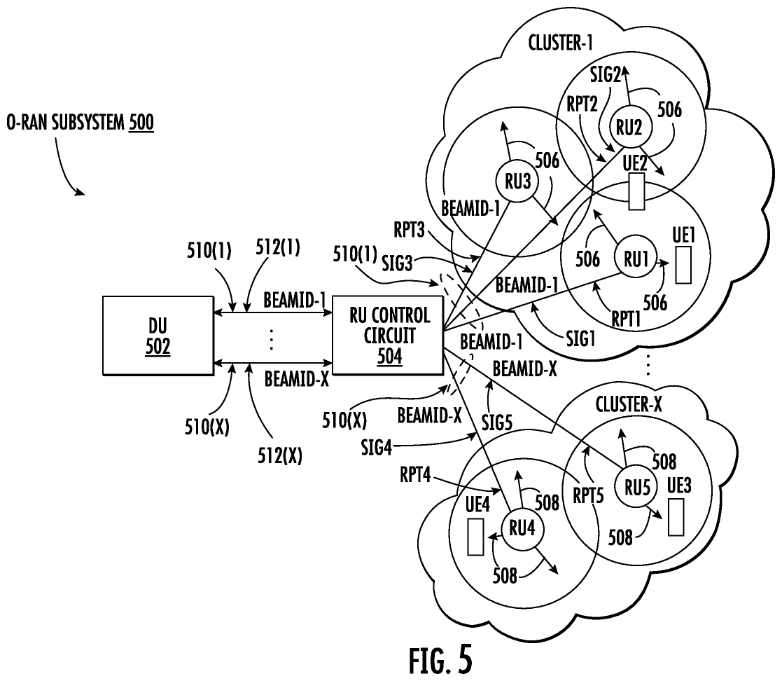

Before discussing an O-RAN subsystem in a WCS that is configured to communicate via radio frequency (RF) beamforming and support remote unit cluster optimization, starting at FIG. 4, a brief overview of a conventional beamforming system is first provided with reference to FIGS. 3A-3E to help explain some fundamental aspects related to RF beamforming.

FIG. 3A is a schematic diagram of an RF beamforming system 300 wherein an antenna array 302 emits an RF beam(s) 304 toward one or more user devices 306. The antenna array 302 includes multiple antenna elements 308 that are typically separated from each other by a distance (a.k.a. “antenna spacing”). The RF beam(s) 304 emitted from the antenna elements 308 includes multiple beamforming signals (not shown). The beamforming signals are preprocessed based on a set of complex-valued coefficients, which is commonly known as a beamforming codeword, and/or further processed to provide phase and/or amplitude changes as needed. Specifically, multiplication of the beamforming codeword is realized by a combination of digital processing and through phase and/or amplitude control applied at an input of the antenna elements 308 to thereby maximize an array gain in a desired beam direction(s) 310. By applying the set of complex-valued coefficients to the beamforming signals, the multiple simultaneously emitted beamforming signals can form the RF beam(s) 304, which may be multiple RF beams each described by gain, intensity, power, and/or electric/magnetic field values versus elevation and azimuth directions. In this regard, it can be said that the RF beam(s) 304 is associated with, or defined by, a respective beamforming codeword. Accordingly, a list of different beamforming codewords, often referred to as a beamforming codebook, can define multiple different RF beams.

Notably, the RF beam(s) 304 often includes a main lobe 312, where radiated power is concentrated and close to a maximum radiated power, and one or more sidelobes 314 with lesser amounts of radiated power. Typically, a radiation direction of the main lobe 312 determines the desired beam direction(s) 310 of the RF beam(s) 304, and a beamwidth of the RF beam(s) 304 is defined by a set of the radiation directions 310 wherein the radiated power is not lower than 3 dB from the maximum radiated power.

The RF beam(s) 304 can be a control beam(s) (a.k.a. reference beam) or a data bearing beam(s). The control beam(s) is radiated periodically in different directions to allow the user devices 306 to discover the antenna array 302 in a transmitting base station (e.g., gNB). Although, in theory, it is possible to increase the number of the RF beam(s) 304 by defining more codewords, an actual number of the RF beam(s) 304 that can be provided by the transmitting base station is typically limited by a standard-defined configuration parameter known as the synchronization signal block (SSB). FIG. 3B is a graphic diagram providing an exemplary illustration of how the SSB limits the actual number of the RF beam(s) 304 that may be formed by the antenna array 302 in the transmitting base station configured to operate according to the fifth generation (5G) and 5G new-radio (5G-NR) technologies.

As shown in FIG. 3B, to allow any of the user devices 306 in an intended coverage area to detect a transmitting base station 316, the antenna array 302 is configured to periodically radiate the RF beam(s) 304 in different directions 318. The RF beam(s) 304 radiated in each of the directions 318 is identified in a respective beam identification (BEAMID) and associated with a respective one of multiple SSBs 320. Each of the SSBs 320 may include such information as a primary synchronization signal (PSS), a secondary synchronization signal (SSS), and a 5G-NR physical broadcast channel (PBCH) to enable the user devices 306 to discover the transmitting base station 316.

The SSBs 320 may be organized into SS burst sets 322 to be repeated periodically based on a predefined SS burst interval. A maximum number of the SSBs 320 that can be provided in each of the SS burst sets 322 is governed by third generation partnership project (3GPP) standard and summarized in Table 1 below. According to Table 1, the maximum number of the SSBs 320 that can be provided in each of the SS burst sets 322 is determined by a carrier frequency (fc). For example, when the carrier frequency is higher than 6 GHZ, the transmitting base station 316 can radiate up to 64 reference beams 304 in 64 different directions 318 during each SS burst interval.

TABLE 1

| Carrier | Max No. of Candidate SSBs |
|---|---|
| Frequency( f_{C}) | Within SS Burst Set (Lmax) |
| f_{C} ≤ 3 GHZ | 4 |
| 3 GHz < f_{C} ≤ 6 GHz | 8 |
| f_{C} > 6 GHz | 64 |

Accordingly, each of the user devices 306 can sweep through the RF beam(s) 304 and radiate in the different directions 318 to identify a candidate reference beam(s) associated with a strongest reference signal received power (RSRP). Further, the user devices 306 may decode a candidate SSB(s) associated with the identified candidate reference beam(s) to acquire such information as physical cell identification (PCI) and a PBCH demodulation reference signal (DMRS). Based on the candidate reference beam(s) reported by the user devices 306, the transmitting base station 316 may pinpoint respective locations of the user devices 306 and subsequently steer a data-bearing RF beam toward each of the user devices 306 to enable data communication.

The 3GPP standard also specifies beam management procedures for the transmitting base station 316 and the user devices 306. FIG. 3C provides an exemplary illustration of the 3GPP beam management procedures, namely a P1 procedure, a P2 procedure, and a P3 procedure.

The P1 procedure (a.k.a. initial beam sweeping) is performed to allow the user devices 306 to discover the transmitting base station 316 by sweeping through the RF beam(s) 304 carrying the SSBs 320 and radiated in the different directions 318. The P1 procedure is performed by both the transmitting base station 316 and the user devices 306 in the sense that the transmitting base station 316 is responsible for periodically radiating the RF beam(s) 304 carrying the SSBs 320 in the different directions 318, while the user devices 306 are responsible for performing wide beam scanning to identify the candidate reference beam(s) among the RF beam(s) 304 radiated in the different directions 318.

The P2 procedure (a.k.a. refinement sweeping) is performed after the user devices 306 have identified the candidate reference beam(s). The P2 procedure is performed for downlink transmit-end beam refinement based on a non-zero-power (NZP) channel state information reference signal (CSI-RS) and for uplink transmit-end beam refinement based on a sounding reference signal (SRS).

In the P3 procedure (a.k.a. user equipment receiving beam refinement sweeping), the transmitting base station 316 transmits CSI-RS to the user devices 306 using the candidate reference beam(s) identified during the P2 procedure. The user devices 306, in turn, can refine the received candidate reference beam(s) to help configure spatial filter on receiving antenna array. Notably, the user devices 306 will only configure the spatial filter when the user devices 306 are capable of supporting beamforming. The transmitting base station 316 also forms and steers the data-bearing RF beam(s) 304 toward the user devices 306 based on the candidate reference beam(s) identified during the P2 procedure.

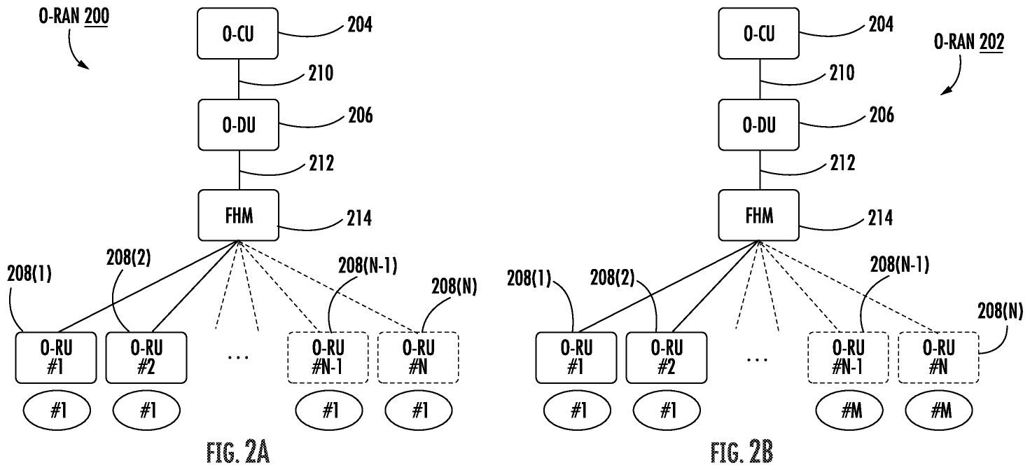

The transmitting base station 316 in FIG. 3B can replace each O-RU 208(1)-208(N) in the O-RAN 202 in FIG. 2B to provide wireless communications in the different cells (#1 . . . #M) based on the beamforming principles and/or procedures described above in FIGS. 3A-3C. Notably, each of the cells (#1 . . . #M) in the O-RAN 202 may be statically configured based on an initial implementation plan and/or site layout. However, ad-hoc movement of the user devices 306 can change the operational dynamics in the cells (#1 . . . #M). For example, some of the cells (#1 . . . #M) may be underutilized whereas some other cells (#1 . . . #M) are becoming overcrowded. Consequently, some or all the cells (#1 . . . #M) may be underperforming in the sense of lower data throughput, poorer coverage, and/or higher power consumption. As such, it is desirable to dynamically optimize the cells (#1 . . . #M) for optimal user experience.

In this regard, FIG. 4 is a schematic diagram of an exemplary WCS 400 configured according to any of the embodiments disclosed herein to enable remote unit cluster optimization. The WCS 400 supports both legacy 4G LTE, 4G/5G non-standalone (NSA), and 5G standalone communications systems. As shown in FIG. 4, a centralized services node 402 (a.k.a. CU) is provided and is configured to interface with a core network to exchange communications data and distribute the communications data as radio signals to various wireless nodes. In this example, the centralized services node 402 is configured to support distributed communications services to a radio node 404 (e.g., 5G or 5G-NR gNB). Despite that only one radio node 404 is shown in FIG. 4, it should be appreciated that the WCS 400 can be configured to include additional numbers of the radio node 404, as needed.

The functions of the centralized services node 402 can be virtualized through, for example, an x2 interface 406 to another services node 408. The centralized services node 402 can also include one or more internal radio nodes that are configured to be interfaced with a distribution unit (DU) 410 to distribute communications signals to one or more open radio access network (O-RAN) remote units (RUs) 412 that are configured to be communicatively coupled through an O-RAN interface 414. The O-RAN RUs 412 are each configured to communicate downlink and uplink communications signals in a respective coverage cell.

The centralized services node 402 can also be interfaced with a distributed communications system (DCS) 415 through an x2 interface 416. Specifically, the centralized services node 402 can be interfaced with a digital baseband unit (BBU) 418 that can provide a digital signal source to the centralized services node 402. The digital BBU 418 may be configured to provide a signal source to the centralized services node 402 to provide downlink communications signals 420D to a digital routing unit (DRU) 422 as part of a digital distributed antenna system (DAS). The DRU 422 is configured to split and distribute the downlink communications signals 420D to different types of remote units, including a low-power remote unit (LPR) 424, a radio antenna unit (dRAU) 426, a mid-power remote unit (dMRU) 428, and a high-power remote unit (dHRU) 430. The DRU 422 is also configured to combine uplink communications signals 420U received from the LPR 424, the dRAU 426, the dMRU 428, and the dHRU 430 and provide the combined uplink communications signals to the digital BBU 418. The digital BBU 418 is also configured to interface with a third-party central unit 432 and/or an analog source 434 through a radio frequency (RF)/digital converter 436.

The DRU 422 may be coupled to the LPR 424, the dRAU 426, the dMRU 428, and the dHRU 430 via an optical fiber-based communications medium 438. In this regard, the DRU 422 can include a respective electrical-to-optical (E/O) converter 440 and a respective optical-to-electrical (O/E) converter 442. Likewise, each of the LPR 424, the dRAU 426, the dMRU 428, and the dHRU 430 can include a respective E/O converter 444 and a respective O/E converter 446.

The E/O converter 440 at the DRU 422 is configured to convert the downlink communications signals 420D into downlink optical communications signals 448D for distribution to the LPR 424, the dRAU 426, the dMRU 428, and the dHRU 430 via the optical fiber-based communications medium 438. The O/E converter 446 at each of the LPR 424, the dRAU 426, the dMRU 428, and the dHRU 430 is configured to convert the downlink optical communications signals 448D back to the downlink communications signals 420D. The E/O converter 444 at each of the LPR 424, the dRAU 426, the dMRU 428, and the dHRU 430 is configured to convert the uplink communications signals 420U into uplink optical communications signals 448U. The O/E converter 442 at the DRU 422 is configured to convert the uplink optical communications signals 448U back to the uplink communications signals 420U.

In an embodiment, the DU 410 can be coupled to the O-RAN RUs 412 via a front-haul multiplexer (FHM) 450, which is functionally equivalent to the FHM 214 in the O-RAN 200 of FIG. 2A and the O-RAN 202 of FIG. 2B. In this regard, the CU 402, the DU 410, the FHM 450, and the O-RAN RUs 412 collectively form an O-RAN subsystem 452 in the WCS 400. Accordingly, the O-RAN subsystem 452 can be configured to operate based on the O-RAN shared-cell topology to support multiple RU clusters.

FIG. 5 is a schematic diagram of an exemplary O-RAN subsystem 500, such as the O-RAN subsystem 452 in the WCS of FIG. 4, that operates based on O-RAN shared-cell topology and configured according to embodiments of the present disclosure to optimize any one or more of a plurality of RU clusters CLUSTER-1-CLUSTER-X. The O-RAN subsystem 500 includes a DU 502, which is functionally equivalent to the DU 410 in FIG. 4, and an RU control circuit 504 that is functionally equivalent to the FHM 450 in FIG. 4. In an embodiment, the DU 502 can be integrated with the RU control circuit 504. In this regard, the functionalities performed by the RU control circuit 504 can also be performed by the DU 502. The O-RAN subsystem 500 also includes a plurality of RUs RU1-RUS that are functionally equivalent to the O-RAN RUs 412 in FIG. 4. Notably, the RUs RU1-RUS are illustrated herein merely as non-limiting examples and shall not be interpreted as being limiting in any sense.

Also, in a non-limiting example, the RUs RU1-RU3 are configured to form the RU cluster CLUSTER-1 and the RUs RU4-RUS are configured to form the RU cluster CLUSTER-X. As an example, the RU cluster CLUSTER-1 can provide downlink and uplink wireless communications with a respective set of user equipment (UEs) UE1, UE2, and the RU cluster CLUSTER-X can provide downlink and uplink wireless communications with a respective set of UEs UE3, UE4.

Herein, each of the RU clusters CLUSTER-1-CLUSTER-X is associated with a respective one of a plurality of beam identifications (ID) BEAMID-1-BEAMID-X. In this regard, the RUs RU1-RU3 in the RU cluster CLUSTER-1 will each form a respective set of RF beam(s) 506 (reference beam and data-bearing beam) using the beam ID BEAMID-1 and in accordance with the beam management procedures described in FIG. 3C. Likewise, the RUs RU4-RU5 in the RU cluster CLUSTER-X will each form a respective set of RF beam(s) 508(reference beam and data-bearing beam) using the beam ID BEAMID-X and in accordance with the beam management procedures described in FIG. 3C.

Herein, the RU control circuit 504 is configured to receive a plurality of link quality reports RPT1-RPT5 from the RUs RU1-RU5, respectively. As an example, the link quality reports RPT1-RPT3 include link quality measurements collected by the respective set of UEs UE1-UE2 with respect to the RUs RU1-RU3 in the RU cluster CLUSTER-1 and the link quality reports RPT4-RPT5 include link quality measurements collected by the respective set of UEs UE3-UE4 with respect to the RUs RU4-RUS in the RU cluster CLUSTER-X. Using the link quality reports RPT1-RPT5, the RU control circuit 504 can determine whether any of the RU clusters CLUSTER-1-CLUSTER-X is underperforming and, thus, need to be optimized to improve performance. Herein, a selected RU cluster(s) among the RU clusters CLUSTER-1-CLUSTER-X may be deemed underperforming if any of the RUs RU1-RU5 in the selected RU cluster(s) is determined to be underutilized (e.g., having a surplus in terms of capacity, bandwidth, and/or processing resources) or overloaded (e.g., suffering a deficit in terms of capacity, bandwidth, and/or processing resource). Accordingly, the RU control circuit 504 will optimize the selected RU cluster(s) when optimization is determined to be necessary.

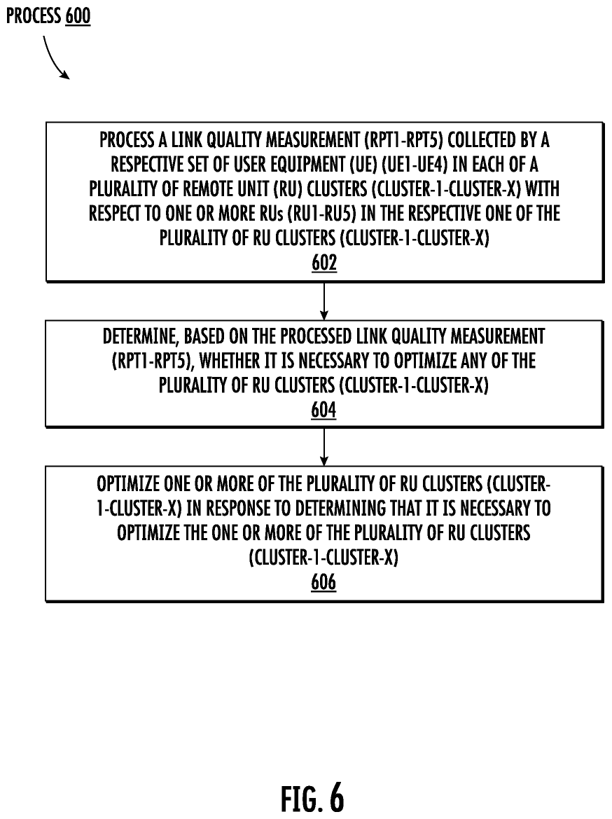

In an embodiment, the RU control circuit 504 can be configured to perform RU cluster optimization in accordance with a process. In this regard, FIG. 6 is a flowchart of an exemplary process 600 whereby the RU control circuit 504 in the O-RAN subsystem 500 of FIG. 5 can support RU cluster optimization.

Herein, the RU control circuit 504 first processes the link quality measurements in the link quality reports RPT1-RPT5, which are collected by the respective set of UEs UE1-UE4 in a respective one of the RU clusters CLUSTER-1-CLUSTER-X with respect to the RUs RU1-RU5 in the respective one of the RU clusters CLUSTER-1-CLUSTER-X (block 602). The RU control circuit 504 then determines, based on the processed link quality measurements received in the link quality reports RPT1-RPT5, whether it is necessary to optimize any of the RU clusters CLUSTER-1-CLUSTER-X (block 604). Accordingly, the RU control circuit 504 optimizes any of the RU clusters CLUSTER-1-CLUSTER-X when the RU control circuit 504 determines that any of the RU clusters CLUSTER-1-CLUSTER-X needs to be optimized (block 606).

With reference back to FIG. 5, the DU 502 is configured to provide a plurality of downlink communication signals 510(1)-510(X) to the RU control circuit 504. Each of the downlink communication signals 510(1)-510(X) is associated with a respective one of the beam IDs BEAMID-1-BEAMID-X. Herein, each of the beam IDs BEAMID-1-BEAMID-X is configured to uniquely identify a respective one of the RU clusters CLUSTER-1-CLUSTER-X. Accordingly, the RU control circuit 504 can forward each of the downlink communication signals 510(1)-510(X) to a respective one of the RU clusters CLUSTER-1-CLUSTER-X identified by the respective one of the beam IDs BEAMID-1-BEAMID-X. Since each of the RU clusters CLUSTER-1-CLUSTER-X can include multiple RUs, the RU control circuit 504 is further configured to replicate each of the downlink communication signals 510(1)-510(X) for every RU in the respective one of the RU clusters CLUSTER-1-CLUSTER-X. For example, the RU control circuit 504 will replicate the downlink communication signals 510(1) using the same beam ID BEAMID-1 and provide the replicated downlink communication signals 510(1) to each of the RUs RU1-RU3 in the RU clusters CLUSTER-1. Likewise, the RU control circuit 504 will replicate the downlink communication signals 510(X) using the same beam ID BEAMID-X and provide the replicated the downlink communication signals 510(X) to each of the RUs RU4-RUS in the RU clusters CLUSTER-X.

The RU control circuit 504 is also configured to receive a respective one of multiple uplink communication signals SIG1-SIG5 from a respective one of the RUs RU1-RU5 in the RU clusters CLUSTER-1-CLUSTER-X. As illustrated herein, the RU control circuit 504 receives the uplink communications signals SIG1-SIG3 respectively from the RUs RU1-RU3 in the RU cluster CLUSTER-1 and receives the uplink communications signals SIG4-SIG5 respectively from the RUs RU4-RU5 in the RU cluster CLUSTER-X. The RU control circuit 504 is further configured to combine a respective one or more of the uplink communication signals SIG1-SIG5 into a respective one of a plurality of summed uplink communication signals 512(1)-512(X). As an example, the RU control circuit 504 combines the uplink communication signals SIG1-SIG3 received respectively from the RUs RU1-RU3 in the RU cluster CLUSTER-1 into the summed uplink communication signals 512(1). Similarly, the RU control circuit 504 also combines the uplink communication signals SIG4-SIG5 received respectively from the RUs RU4-RUS in the RU cluster CLUSTER-X into the summed uplink communication signals 512(X). The RU control circuit 504 will also associate each of the summed uplink communication signals 512(1)-512(X) with a respective one of the beam IDs BEAMID-1-BEAMID-X and provide the summed uplink communication signals 512(1)-512 (X) to the DU 502.

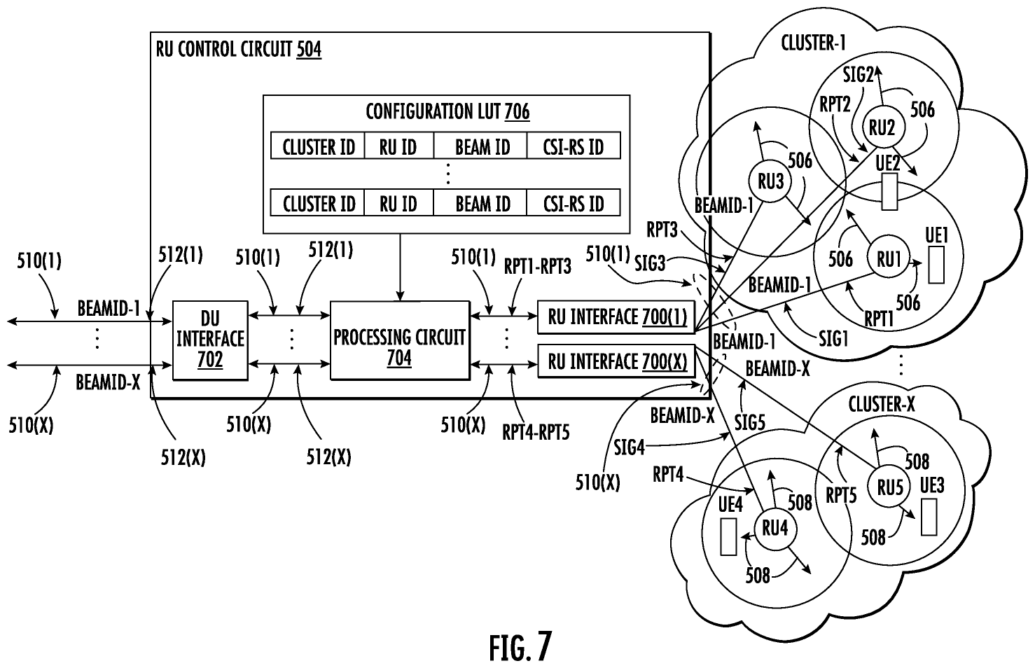

FIG. 7 is a schematic diagram providing an exemplary illustration of the RU control circuit 504 in FIG. 5 that is configured according to an embodiment of the present disclosure. Common elements between FIGS. 5 and 7 are shown therein with common element numbers and will not be re-described herein.

In an embodiment, the RU control circuit 504 includes a plurality of RU interfaces 700(1)-700(X). Each of the RU interfaces 700(1)-700(X) is coupled to a respective one of the RU clusters CLUSTER-1-CLUSTER-X. In one aspect, the RU control circuit 504 provides each of the downlink communication signals 510(1)-510(X) to a respective one of the RU clusters CLUSTER-1-CLUSTER-X via a respective one of the RU interfaces 700(1)-700(X). In another aspect, the RU control circuit 504 receives each of the link quality reports RPT1-RPT5 from a respective one of the RUs RU1-RUS, which is in a respective one of the RU clusters CLUSTER-1-CLUSTER-X, via a respective one of the RU interfaces 700(1)-700(X).

The RU control circuit 504 also includes a DU interface 702 that is coupled to the DU 502 in FIG. 5. Herein, the DU interface 702 is configured to receive the downlink communication signals 510(1)-510(X) from the DU 502 and provide the summed uplink communication signals 512(1)-512(X) to the DU 502.

The RU control circuit 504 further includes a processing circuit 704. The processing circuit 704 is coupled to the DU interface 702 as well as the RU interfaces 700(1)-700(X). In an embodiment, the processing circuit 704 can be a field-programmable gate array (FPGA) or an application-specific integrated circuit (ASIC) configured to execute a software program to carry out the RU functionalities described herein. In another embodiment, the processing circuit 704 can be implemented by software executing on a hardware platform provided in the RU control circuit 504 or the DU 502.

In an embodiment, the RU control circuit 504 can include a configuration lookup table (LUT) 706. In a non-limiting example, the configuration LUT 706 can be preloaded onto the RU control circuit 504 during initial configuration or recalibration of the O-RAN subsystem 500 of FIG. 5. As an example, the configuration LUT 706 can be configured to correlate each of the RUs RU1-RUS with a respective one of the RU clusters CLUSTER-1-CLUSTER-X and/or accordingly with a respective one of the beam IDs BEAMID-1-BEAMID-X corresponding to the respective one of the RU clusters CLUSTER-1-CLUSTER-X. In this regard, the RU control circuit 504 may determine from the configuration LUT 706 as to how to forward each of the downlink communication signals 510(1)-510(X) to the RU clusters CLUSTER-1-CLUSTER-X. The RU control circuit 504 may also determine from the configuration LUT 706 as to how to combine the uplink communication signals SIG1-SIG5 into each of the summed uplink communication signals 512(1)-512(X).

The processing circuit 704 is configured to receive the link quality reports RPT1-RPT5 from the RUs RU1-RU5 in the RU clusters CLUSTER-1-CLUSTER-X. In an embodiment, the link quality reports RPT1-RPT5 include link quality measurements collected by each of the UEs UE1-UE4 with respect to one or more respective RUs among the RUs RU1-RU5 in the respective one of the RU clusters CLUSTER-1-CLUSTER-X. For example, the link quality reports RPT1-RPT3 can each include the link quality measurements collected by the UEs UE1-UE2 with respect to the RUs RU1-RU3 in the RU cluster CLUSTER-1. Likewise, the link quality reports RPT4-RPT5 can each include the link quality measurements collected by the UEs UE3-UE4 with respect to the RUs RU4-RUS in the RU cluster CLUSTER-X.

The processing circuit 704 can process the received the link quality reports RPT1-RPT5 to extrapolate and/or consolidate link quality measurements collected by the respective set of UEs UE1-UE4 in each the RU clusters CLUSTER-1-CLUSTER-X. Such processed link quality measurements can provide a picture as to whether any of the RUs RU1-RUS is underutilized or overloaded. For example, in the RU cluster CLUSTER-1, the UE UE1 is within the communication range of RU RU1, while the UE UE2 is within the communication ranges of RUs RU1 and RU2. In the meantime, none of the UEs UE1 and UE2 is within the communication range of the RU RU3. In this regard, the link quality measurement collected by the UE UE1 will provide link quality information with respect to the RU RU1, the link quality measurement collected by the UE UE2 will provide link quality information with respect to the RUs RU1 and RU2, and no link quality measurement may be available with respect to the RU RU3. In this regard, the processing circuit 704 can learn several things about the RU cluster CLUSTER-1. The processing circuit 704 may first determine that the RU RU3 is underutilized (a.k.a. idle) and is not contributing to overall performance (throughput, coverage, etc.) of the RU cluster CLUSTER-1. The processing circuit 704 may also determine that the RU RU1 is serving more UEs (UE1 and UE2) than the RU RU2 (UE2 only) in the RU cluster CLUSTER-1. Accordingly, the processing circuit 704 may further examine whether the RU RU1 is overloaded. The processing circuit 704 may further determine which of the RUs RU1-RU2 can provide a higher quality link (downlink and uplink) for the UE UE2.

Thus, based on the processed link quality measurements in each of the RU clusters CLUSTER-1-CLUSTER-X, the processing circuit 704 can determine whether there is a need to optimize any of the RU clusters CLUSTER-1-CLUSTER-X. In other words, the processing circuit 704 will determine whether any of the RU clusters CLUSTER-1-CLUSTER-X is underperforming in the sense of coverage, throughput, and/or power consumption. Accordingly, the processing circuit 704 can perform one or more optimization tasks to thereby optimize any of the RU clusters CLUSTER-1-CLUSTER-X that needs optimization.

As an example, the table (Table 2) below represents an exemplary overall link quality survey that the RU control circuit 504 can extrapolate from the link quality reports RPT1-RPT5 received from the RU clusters CLUSTER-1 and CLUSTER-X. Notably in Table 2, “11” represents a stronger link quality measurement, “1” represents a weaker link quality measurement (1<11), and “x” represents the weakest link quality measurement (x<↑<↑↑) and/or absence of the link quality measurement.

TABLE 2

| | CLUSTER-1 | | | CLUSTER-X | |
|---|---|---|---|---|---|
| | RU1 | RU2 | RU3 | RU4 | RU5 |
| UE1 | ↑↑ | x | x | x | x |
| UE2 | ↑↑ | ↑ | x | x | x |
| UE3 | x | x | x | x | ↑↑ |
| UE4 | x | x | x | ↑ | x |

From the overall link quality survey above, the RU control circuit 504 can determine that the RU RU1 is serving more UEs with stronger link quality. Accordingly, the RU control circuit 504 may add more capacity to the RU RU1 to prevent overloading and/or direct more data traffic toward the RU RU1 to help improve throughput and/or coverage. The RU control circuit 504 can also determine that the RUs RU2, RU4, and RU5 are each serving a lesser number of UEs than the RU RU1. Accordingly, the RU control circuit 504 may maintain current resource allocation and/or data traffic flow for the RUs RU2, RU4, and RU5. The RU control circuit 504 may further determine that the RU RU3 is not serving any of the UEs UE1-UE5 (a.k.a. underutilized). Accordingly, the RU control circuit 504 may scale back resource allocation and/or data traffic flow for the RU RU3.

In an embodiment, the UEs UE1-UE4 may collect the link quality measurements during the P2 procedure in FIG. 3C. More specifically, the UEs UE1-UE4 may collect the link quality measurements by measuring the RSRP of the CSI-RS signal received with the SSBs 320. The 3GPP standard allows each of the SSBs 320 to include multiple CSI-RS signals, each identified by a respective unique CSI-RS ID. For example, a set of four (4) CSI-RS signals, each identified by an identical CSI-RS ID, can be associated with each of the SSBs 320. In this regard, each of the RUs RU1-RU5 may be configured to apply different beamforming coefficients to thereby steer the 4 CSI-RS signals toward 4 different directions.

If each of the SS burst set 322 is configured to include eight (8) SSBs 320, then a total of thirty-two (32) CSI-RS signals can be uniquely identified in each of the RU clusters CLUSTER-1-CLUSTER-X. As such, if each of the RU clusters CLUSTER-1-CLUSTER-X includes less than or equal to 8 RUs, then each of the RUs can be identified by a unique CSI-RS ID, which may be stored in the configuration LUT 706 in association with the RU ID. Thus, by measuring the RSRP of the respective CSI-RS signals identified by the respective CSI-RS IDs, each of the UEs UE1-UE4 can collect the link quality measurements for any of the RUs RU1-RU5. Notably, however, if any of the RU clusters CLUSTER-1-CLUSTER-X includes more than 8 RUs, it is then necessary to increase the number of SSBs 320 in the SS burst set 322, as permitted by the 3GPP standard, or reuse the CSI-RS IDs among multiple RUs (e.g., with reduced granularity). In an embodiment, CSI-RS ID reuse can be implemented by reassigning a unique CSI-RS ID to a different RU during different scannings.

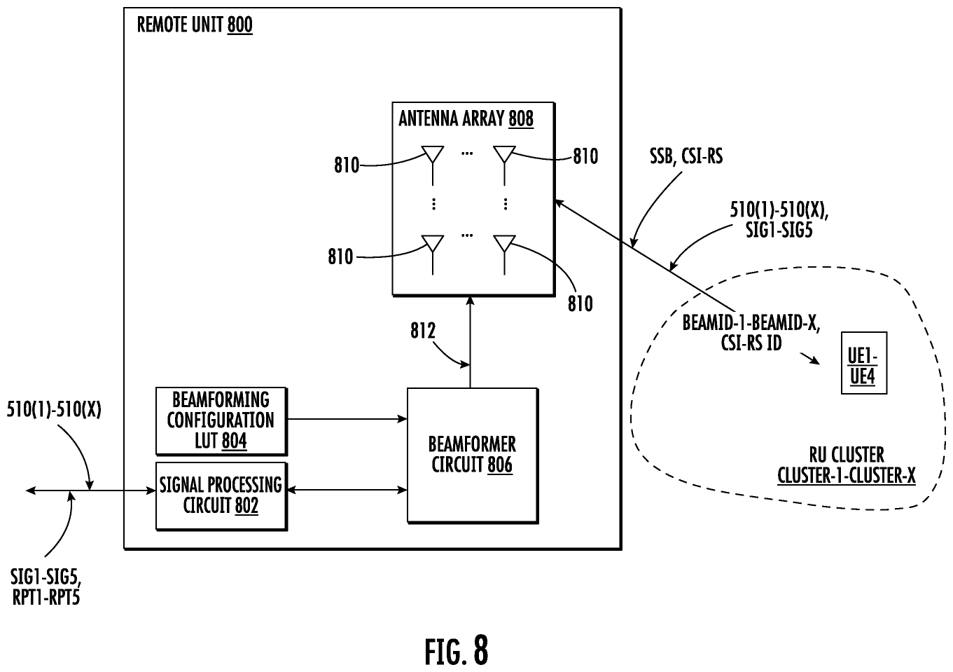

FIG. 8 is a schematic diagram of an exemplary RU 800 that can be configured to function as any of the RUs RU1-RU5 in FIG. 7. Common elements between FIGS. 7 and 8 are shown therein with common element numbers and will not be re-described herein.

In an embodiment, the RU 800 includes a signal processing circuit 802, a beamforming configuration LUT 804, a beamformer circuit 806, and an antenna array 808, which includes a plurality of antenna elements 810. The signal processing circuit 802 is configured to receive a respective one of the downlink communication signals 510(1)-510(X) from the RU control circuit 504 and provide a respective one or more of the uplink communication signals SIG1-SIG5 to the RU control circuit 504. The signal processing circuit 802 is further configured to process the link quality measurements collected by a respective set of the UEs UE1-UE4 to generate a respective one of the link quality reports RPT1-RPT5 and provide the respective one of the link quality reports RPT1-RPT5 to the RU control circuit 504.

The beamforming configuration LUT 804 may be preconfigured to store one or more beamforming codewords, each including a set of beamforming coefficients. The beamformer circuit 806 can be configured to provide different sets of beamforming signals 812 to the antenna array 808. For example, the different sets of beamforming signals 812 can be formed to communicate the SSBs 320 during the P1 procedure, to communicate the CSI-RS signals during the P2 procedure, or to communicate the respective one of the downlink communication signals 510(1)-510(X) and/or the respective one of the uplink communication signals SIG1-SIG5 after the P3 procedure. In an embodiment, the beamformer circuit 806 may generate the different sets of beamforming signals 812 based on the beamforming codewords stored in the beamforming configuration LUT 804.

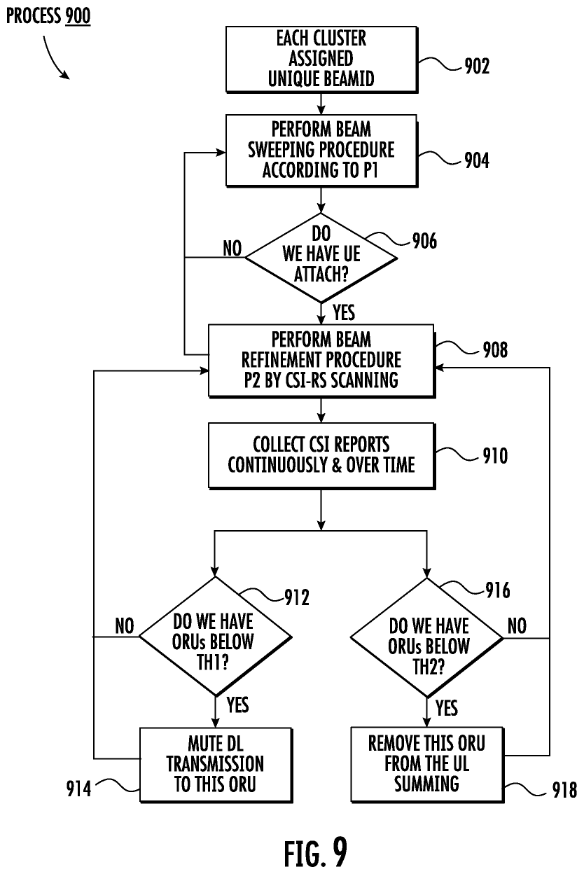

The RU control circuit 504 in the O-RAN subsystem 500 of FIG. 5 can be configured to perform one or more optimization tasks in one or more of the RU clusters CLUSTER-1-CLUSTER-X after the P1 procedure and coincide with the P2 procedure. In a non-limiting example, the optimization tasks can include muting/unmuting downlink communication for any of the RUs RU1-RU5, muting/unmuting uplink communications of any of the RUs RU1-RUS, and/or re-clustering any of the RUs RU1-RU5. In this regard, FIGS. 9-11 are flowcharts of exemplary processes that can be employed in the O-RAN subsystem 500 of FIG. 5 to perform the optimization tasks. Elements in FIGS. 7 and 8 are referenced herein in FIGS. 9-11 with common element numbers and will not be re-described herein.

FIG. 9 is a flowchart of an exemplary process 900 that can be employed in the O-RAN subsystem 500 of FIG. 5 to selectively mute any of the RUs RU1-RU5 with respect to downlink and uplink communications. Herein, the configuration LUT 706 may be preconfigured to uniquely identify each of the RU clusters CLUSTER-1-CLUSTER-X with a respective one of the BEAM IDs BEAMID-1-BEAMID-X (block 902). Each of the RUs RU1-RU5 is configured to perform the P1 procedure (a.k.a. beam sweeping procedure) (block 904). Each of the RUs RU1-RUS is configured to determine whether any of the UEs UE1-UE4 is attached (block 906). If no UE is attached, each of the RUs RU1-RU5 then returns to block 904. Otherwise, each of the RUs RU1-RUS will conduct the P2 procedure (a.k.a. beam refinement procedure) by CSI-RS scanning (block 908). Each of the RUs RU1-RU5 is further configured to collect the link quality measurements, either continuously or over time, from a respective set of the UEs UE1-UE4 (block 910) and provide a respective one of the link quality reports RPT1-RPT5 to the RU control circuit 504. The RU control circuit 504 is configured to determine whether the link quality measurement is below a muting threshold TH1 for any of the RUs RU1-RU5 (block 912). If so, the RU control circuit 504 can mute downlink transmission to the determined RU among the RUs RU1-RU5 by stopping forwarding of a respective one of the downlink communication signals 510(1)-510(X) to the determined RU (block 914). Otherwise, the RU control circuit 504 can return to block 908. The RU control circuit 504 is also configured to determine whether the link quality measurement is below a non-combining threshold TH2 for any of the RUs RU1-RU5 (block 916). If so, the RU control circuit 504 can mute uplink transmission from the determined RU among the RUs RU1-RU5 by stopping the combining of a respective one of the uplink communication signals SIG1-SIG5 into a respective one of the summed uplink communication signals 512(1)-512(X) (block 918). Otherwise, the RU control circuit 504 can return to block 908. In an embodiment, the RU control circuit 504 may add any of the RUs RU1-RUS that is muted in the downlink and/or uplink into a watch list.

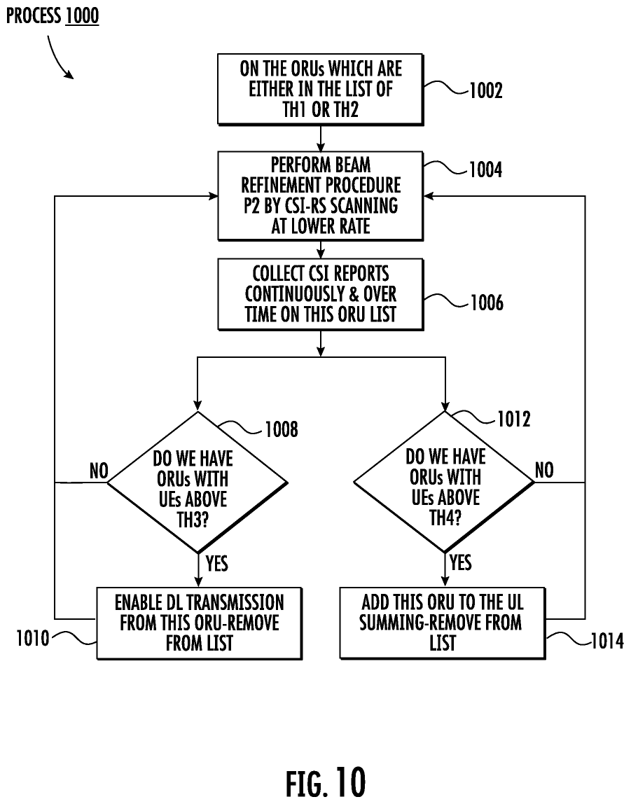

FIG. 10 is a flowchart of an exemplary process 1000 that can be employed in the O-RAN subsystem 500 of FIG. 5 to selectively unmute any of the RUs RU1-RUS that is placed in the watch list during the process 900 of FIG. 9. Herein, the RU control circuit 504 is configured to monitor any of the RUs RU1-RU5 that were placed in the watch list during the process 900 of FIG. 9 (block 1002). Each of the RUs RU1-RU5 in the watch list is configured to conduct the P2 procedure (a.k.a. beam refinement procedure) by CSI-RS scanning at a lower rate (block 1004). Each of the RUs RU1-RUS in the watch list is also configured to collect CSI-RS measurements from the respective set of UEs UE1-UE4, continuously and over time (block 1006) and report to the RU control circuit 504 in the respective one of the link quality reports RPT1-RPT5.

The RU control circuit 504 is configured to determine whether the link quality measurement is above an unmuting threshold TH3 (TH3>TH1) for any of the RUs RU1-RU5 (block 1008). If so, the RU control circuit 504 can unmute downlink transmission to the determined RU among the RUs RU1-RU5 by resuming the forwarding of a respective one of the downlink communication signals 510(1)-510(X) to the determined RU (block 1010). Otherwise, the RU control circuit 504 can return to block 1004. The RU control circuit 504 is also configured to determine whether the link quality measurement is above a combining threshold TH4 (TH4 >TH2) for any of the RUs RU1-RU5 (block 1012). If so, the RU control circuit 504 can unmute uplink transmission from the determined RU among the RUs RU1-RU5 by resuming the combining of a respective one of the uplink communication signals SIG1-SIG5 into a respective one of the summed uplink communication signals 512(1)-512(X) (block 1014). Otherwise, the RU control circuit 504 can return to block 1004.

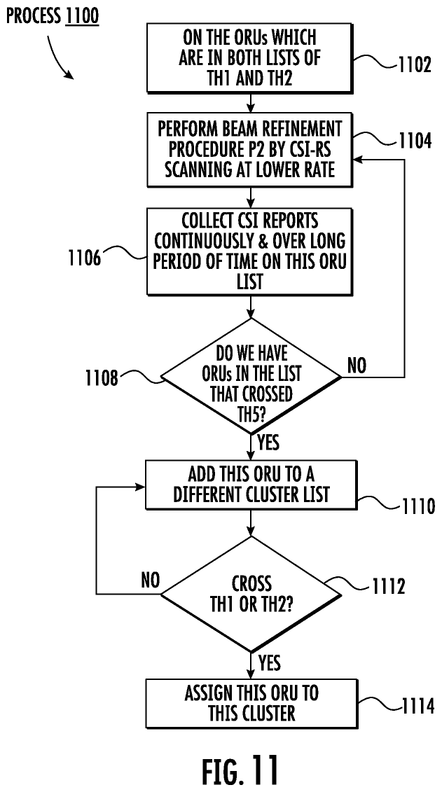

FIG. 11 is a flowchart of an exemplary process 1100 that can be employed in the O-RAN subsystem 500 of FIG. 5 to selectively re-cluster any of the RUs RU1-RUS that is placed in the watch list during the process 900 of FIG. 9. Herein, the RU control circuit 504 is configured to monitor any of the RUs RU1-RUS that were placed in the watch list during the process 900 of FIG. 9 (block 1102). Each of the RUs RU1-RU5 in the watch list is configured to conduct the P2 procedure (a.k.a. beam refinement procedure) by CSI-RS scanning at a lower rate (block 1104). Each of the RUs RU1-RU5 in the watch list is also configured to collect CSI-RS measurements from the respective set of UEs UE1-UE4, continuously and over an extended period (block 1106) and report to the RU control circuit 504 in the respective one of the link quality reports RPT1-RPT5.

The RU control circuit 504 will determine whether any of the RUs RU1-RU5 has been placed in the watch list beyond a predefined time limit TH5 (e.g., weeks or months) (block 1108). If not, the RU control circuit 504 will return to block 1104. Otherwise, the RU control circuit 504 will re-cluster the determined RU in the watch list from a current one of the RU clusters CLUSTER-1-CLUSTER-X to a different one of the RU clusters CLUSTER-1-CLUSTER-X (block 1110). The RU control circuit 504 the checks whether link quality measurement associated with the re-clustered RU is below the muting threshold TH1 or the non-combining threshold TH2 (block 1112). If not, the RU control circuit 504 returns to block 1110. Otherwise, the RU control circuit 540 may re-cluster the re-clustered RU to yet another one of the RU clusters CLUSTER-1-CLUSTER-X (block 1114).

In an embodiment, the RU control circuit 504 may gather statistics over long period of time of all RUs in all clusters. Accordingly, the RU control circuit 504 may create a table and score each RU according to respective utilization. The RU control circuit 504 may then take the lower scored RUs, one at a time, and try to allocate each of the lower scored RUs to a different cluster to see whether the score will improve. If so, it means that it will be better off to allocate the specific RU to the new cluster.

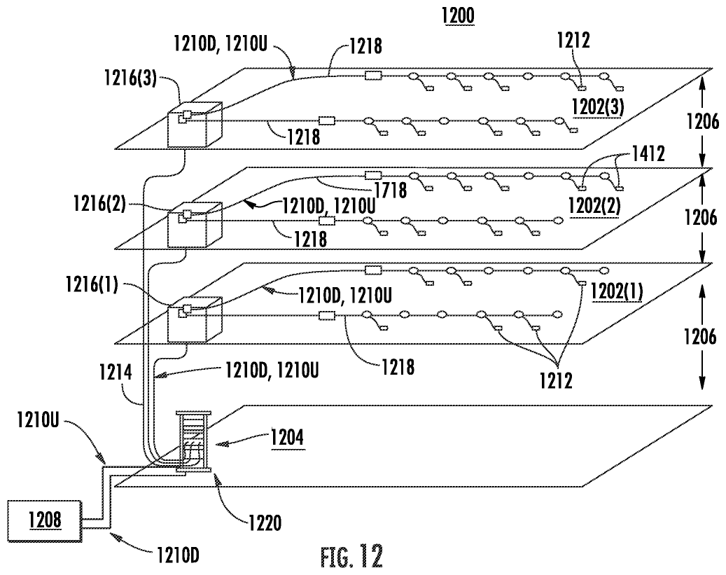

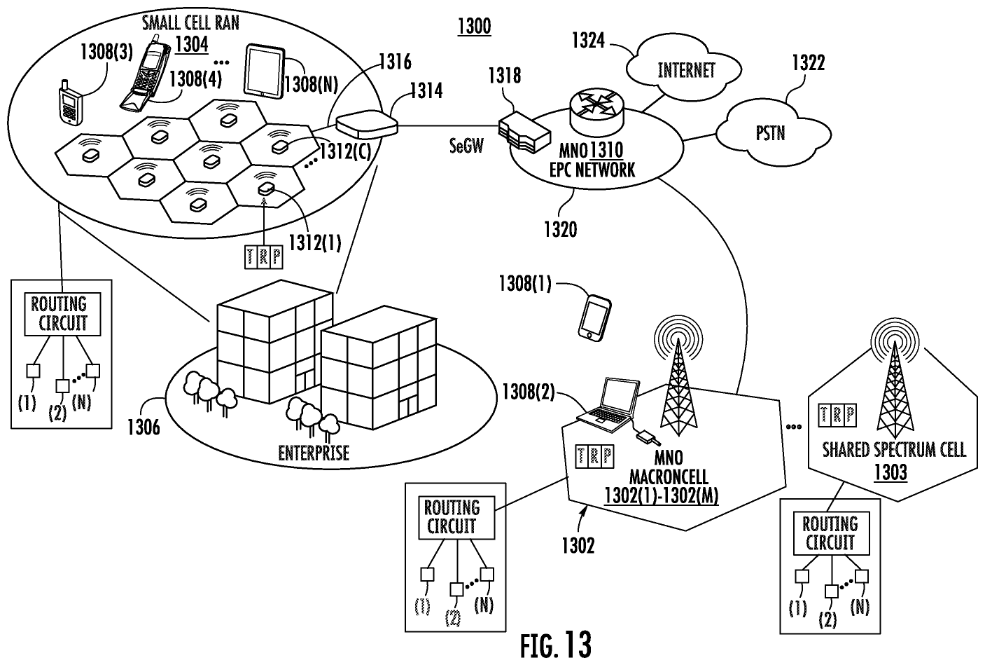

FIG. 12 is a partial schematic cut-away diagram of an exemplary building infrastructure 1200 that includes an exemplary RAN system 1202, including but not limited to the O-RAN subsystem 500 of FIG. 5, wherein the RAN system 1202 includes multiple RANs 1204 implemented according to a RAN standard (e.g., O-RAN standard) and each configured to transparently interface with shared RUs through an intermediary neutral host agent device. The building infrastructure 1200 in this embodiment includes a first (ground) floor 1202(1), a second floor 1202 (2), and a third floor 1202(3). The floors 1202(1)-1202(3) are serviced by one or more RANs 1204 to provide antenna coverage areas 1206 in the building infrastructure 1200. The RANs 1204 are communicatively coupled to a core network 1208 to receive downlink communications signals 1210D (downlink communications signals 1210D can include downlink channels) from the core network 1208. The RANs 1204 are communicatively coupled to a respective plurality of RUs 1212 to distribute the downlink communications signals 1210D to the RUs 1212 and to receive uplink communications signals 1210U (uplink communications signals 1210U can include uplink channels) from the RUs 1212, as previously discussed above. Any RU 1212 can be shared by any of the multiple RANs 1204. A neutral host agent 1220 like the neutral host agent devices 418, 1918 in FIGS. 4, 9, 11, and 14 may be provided that is configured to transparently interface a shared RU(s) 1212 to the RAN 1204 according to a RAN standard (e.g., O-RAN standard).

The downlink communications signals 1210D and the uplink communications signals 1210U communicated between the RANs 1204 and the RUs 1212 are carried over a riser cable 1214. The riser cable 1214 may be routed through interconnect units (ICUs) 1216(1)-1216(3) dedicated to each of the floors 1202(1)-1202(3) that route the downlink communications signals 1210D and the uplink communications signals 1210U to the RUs 1212 and also provide power to the RUs 1212 via array cables 1218.

FIG. 13 is a schematic diagram of an exemplary mobile telecommunications RAN system 1300 (also referred to as “RAN system 1300”) that can include, but is not limited to, the O-RAN subsystem 500 of FIG. 5, wherein the RAN system 1300 includes multiple RANs implemented according to a RAN standard (e.g., O-RAN standard) and each configured to transparently interface with shared RUs through an intermediary neutral host agent device.

In this regard, a RAN system 1300 includes exemplary macrocell RANs 1302(1)-1302(M) (“macrocells 1302(1)-1302(M)”) and an exemplary small cell RAN 1304 located within an enterprise environment 1306 and configured to service mobile communications between a user mobile communications device 1308(1)-1308(N) to a mobile network operator (MNO) 1310. A serving RAN for the user mobile communications devices 1308(1)-1308(N) is a RAN or cell in the RAN in which the user mobile communications devices 1308(1)-1308(N) have an established communications session with the exchange of mobile communications signals for mobile communications. Thus, a serving RAN may also be referred to herein as a serving cell. For example, the user mobile communications devices 1308(3)-1308(N) in FIG. 13 are being serviced by the small cell RAN 1304, whereas the user mobile communications devices 1308(1) and 1308(2) are being serviced by the macrocell 1302. The macrocell 1302 is an MNO macrocell in this example. The macrocell 1302 can be or include a wireless device(s) that can be configured to selectively control whether received transmit channels are transmitted through an antenna array of the wireless device. However, a shared spectrum RAN 1303 (also referred to as “shared spectrum cell 1303”) includes a macrocell in this example and supports communications on frequencies that are not solely licensed to a particular MNO, such as CBRS for example, and thus may service user mobile communications devices 1308(1)-1308(N) independent of a particular MNO. The macrocell 1302 can be or include a wireless device(s) that can be configured to selectively control whether received transmit channels are transmitted through an antenna array of the wireless device. The macrocell 1302 can be a wireless device that can be configured to selectively control whether received transmit channels are transmitted through an antenna array of the wireless device. For example, the shared spectrum cell 1303 may be operated by a third party that is not an MNO and wherein the shared spectrum cell 1303 supports CBRS. The MNO macrocell 1302, the shared spectrum cell 1303, and the small cell RAN 1304 may be neighboring radio access systems to each other, meaning that some or all can be in proximity to each other such that a user mobile communications device 1308(3)-1308(N) may be able to be in communications range of two or more of the MNO microcell(s) 1302, the shared spectrum cell 1303, and the small cell RAN 1304 depending on the location of the user mobile communications devices 1308(3)-1308(N).

In FIG. 13, the RAN system 1300 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The RAN system 1300 includes the enterprise environment 1306 in which the small cell RAN 1304 is implemented. The small cell RAN 1304 includes a plurality of small cell radio nodes 1312(1)-1312 (C), which are wireless devices that can be configured to selectively control whether received transmit channels are transmitted through an antenna array of the wireless devices. Each small cell radio node 1312(1)-1312 (C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 13, the small cell RAN 1304 includes one or more services nodes (represented as a single services node 1314) that manage and control the small cell radio nodes 1312(1)-1312 (C). In alternative implementations, the management and control functionality may be incorporated into a radio node, distributed among nodes, or implemented remotely (i.e., using infrastructure external to the small cell RAN 1304). The small cell radio nodes 1312(1)-1312 (C) are coupled to the services node 1314 over a direct or local area network (LAN) connection 1316 as an example, typically using secure IPsec tunnels. The small cell radio nodes 1312(1)-1312 (C) can include multi-operator radio nodes. A neutral host agent device 1315 could be provided between the services node 1314 and the small cell radio nodes 1312(1)-1312 (C) to transparently manage communications between the services node 1314 and shared small cell radio nodes 1312(1)-1312 (C). The services node 1314 aggregates voice and data traffic from the small cell radio nodes 1312(1)-1312 (C) and provides connectivity over an IPsec tunnel to a security gateway (SeGW) 1318 in a network 1320 (e.g., evolved packet core (EPC) network in a 4G network, or 5G Core in a 5G network) of the MNO 1310. The network 1320 is typically configured to communicate with a public switched telephone network (PSTN) 1322 to carry circuit-switched traffic, as well as for communicating with an external packet-switched network such as the Internet 1324.

The RAN system 1300 also generally includes a node (e.g., eNodeB or gNodeB) base station, or “macrocell” 1302. The radio coverage area of the macrocell 1302 is typically much larger than that of a small cell where the extent of coverage often depends on the base station configuration and surrounding geography. Thus, a given user mobile communications device 1308(3)-1308(N) may achieve connectivity to the network 1320(e.g., EPC network in a 4G network, or 5G Core in a 5G network) through either a macrocell 1302 or small cell radio node 1312(1)-1312 (C) in the small cell RAN 1304 in the RAN system 1300. The neutral host agent device 1315 could be provided between the macrocell 1302 and the small cell RAN 1304 to transparently manage communications between the macrocell 1302 and the small cell RAN 1304.

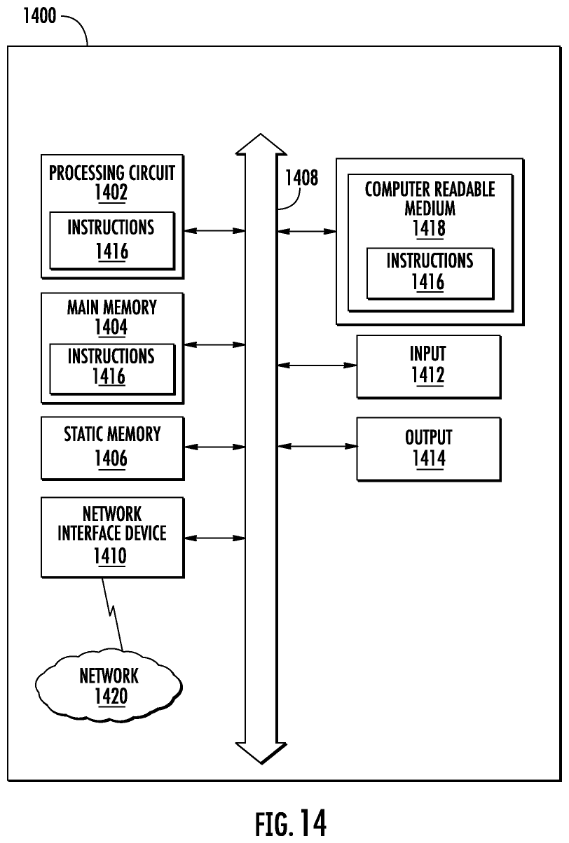

Any of the circuits, components, devices, modules described herein, including but not limited to the RU control circuit 504 in FIGS. 5 and 7, can include or be included in a computer system 1400, such as that shown in FIG. 14, to carry out their functions and operations as described herein. With reference to FIG. 14, the computer system 1400 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1400 in this embodiment includes a processing circuit or processor 1402, a main memory 1404 (e.g., read-only memory (ROM), flash memory, dynamic random-access memory (DRAM) such as synchronous DRAM (SDRAM), etc.), and a static memory 1406 (e.g., flash memory, static random access memory (SRAM), etc.), which may communicate with each other via a data bus 1408. Alternatively, the processing circuit 1402 may be connected to the main memory 1404 and/or static memory 1406 directly or via some other connectivity means. The processing circuit 1402 may be a controller, and the main memory 1404 or static memory 1406 may be any type of memory.

The processing circuit 1402 represents one or more general-purpose processing circuits such as a microprocessor, central processing unit, or the like. More particularly, the processing circuit 1402 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1402 is configured to execute processing logic in instructions 1416 for performing the operations and steps discussed herein.

The computer system 1400 may further include a network interface device 1410. The computer system 1400 also may or may not include an input 1412 to receive input and selections to be communicated to the computer system 1400 when executing instructions. The computer system 1400 also may or may not include an output 1414, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1400 may or may not include a data storage device that includes instructions 1416 stored in a computer-readable medium 1418. The instructions 1416 may also reside, completely or at least partially, within the main memory 1404 and/or within the processing circuit 1402 during execution thereof by the computer system 1400, the main memory 1404 and the processing circuit 1402 also constituting the computer-readable medium 1418. The instructions 1416 may further be transmitted or received over a network 1420 via the network interface device 1410.

While the computer-readable medium 1418 is shown in an exemplary embodiment to be a single medium, the term “computer-readable medium” should be taken to include a single medium or multiple media (e.g., a centralized or distributed database, and/or associated caches and servers) that store the one or more sets of instructions. The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. The term “computer-readable medium” and “machine-readable medium” shall also be taken to include any medium that is capable of storing, encoding or carrying a set of instructions for execution by the processing circuit and that cause the processing circuit to perform any one or more of the methodologies of the embodiments disclosed herein. For example, a computer-readable medium or a machine-readable medium includes a machine-readable storage medium (e.g., read only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A remote unit (RU) control circuit, comprising:
a plurality of RU interfaces each coupled to one or more RUs in a respective one of a plurality of RU clusters associated with a respective one of a plurality of beam identifications (BEAMIDs), wherein the one or more RUs in each of the plurality of RU clusters are configured to communicate with a respective set of user equipment (UE) based on the respective one of the plurality of BEAMIDs; and
a processing circuit coupled to the plurality of RU interfaces and configured to:
process a link quality measurement collected by the respective set of UE in each of the plurality of RU clusters with respect to the one or more RUs in the respective one of the plurality of RU clusters;
determine, based on the processed link quality measurement, whether it is necessary to optimize any of the plurality of RU clusters; and
optimize one or more of the plurality of RU clusters in response to determining that it is necessary to optimize the one or more of the plurality of RU clusters.

2. The RU control circuit of claim 1, wherein the processing circuit is further configured to:
receive a plurality of downlink communication signals each corresponding to a respective one of the plurality of BEAMIDs;
forward each of the plurality of downlink communication signals to the one or more RUs in a respective one of the plurality of RU clusters associated with the respective one of the plurality of BEAMIDs;
receive one or more uplink communication signals respectively from the one or more RUs in each of the plurality of RU clusters; and
combine the one or more uplink communication signals into a respective one of a plurality of summed uplink communication signals corresponding to the respective one of the plurality of BEAMIDs associated with the respective one of the plurality of RU clusters.

3. The RU control circuit of claim 2, wherein the processing circuit is further configured to:
determine that the link quality measurement collected by the respective set of UE in a respective one of the plurality of RU clusters with respect to any of the one or more RUs in the respective one of the plurality of RU clusters is below a muting threshold; and
optimize the respective one of the plurality of RU clusters by stopping forwarding of the respective one of the plurality of downlink communication signals to the determined one of the one or more RUs.

4. The RU control circuit of claim 3, wherein the processing circuit is further configured to:
determine that the link quality measurement collected by the respective set of UE in the respective one of the plurality of RU clusters with respect to any of the one or more RUs in the respective one of the plurality of RU clusters changes from being below the muting threshold to being above an unmuting threshold higher than the muting threshold; and
optimize the respective one of the plurality of RU clusters by resuming the forwarding of the respective one of the plurality of downlink communication signals to the determined one of the one or more RUs.

5. The RU control circuit of claim 3, wherein the processing circuit is further configured to optimize the respective one of the plurality of RU clusters by re-clustering the determined one of the one or more RUs to a different one of the plurality of RU clusters in response to stopping the forwarding of the respective one of the plurality of downlink communication signals to the determined one of the one or more RUs for a predefined time limit.

6. The RU control circuit of claim 2, wherein the processing circuit is further configured to:
determine that the link quality measurement collected by the respective set of UE in a respective one of the plurality of RU clusters with respect to any of the one or more RUs in the respective one of the plurality of RU clusters is below a non-combining threshold; and
optimize the respective one of the plurality of RU clusters by stopping combining of a respective one of the one or more uplink communication signals received from the determined one of the one or more RUs into the respective one of the plurality of summed uplink communication signals.

7. The RU control circuit of claim 6, wherein the processing circuit is further configured to:
determine that the link quality measurement collected by the respective set of UE in the respective one of the plurality of RU clusters with respect to any of the one or more RUs in the respective one of the plurality of RU clusters changes from being below the non-combining threshold to being above a combining threshold higher than the non-combining threshold; and
optimize the respective one of the plurality of RU clusters by resuming the combining of the respective one of the one or more uplink communication signals received from the determined one of the one or more RUs into the respective one of the plurality of summed uplink communication signals.

8. The RU control circuit of claim 6, wherein the processing circuit is further configured to optimize the respective one of the plurality of RU clusters by re-clustering the determined one of the one or more RUs to a different one of the plurality of RU clusters in response to stopping the combining of the respective one of the one or more uplink communication signals received from the determined one of the one or more RUs into the respective one of the plurality of summed uplink communication signals for a predefined time limit.

9. The RU control circuit of claim 1, wherein the processing circuit is further configured to:
determine a set of reference signal identifications for each of the plurality of BEAMIDs;
generate a set of reference signals each corresponding to a respective one of the set of reference signal identifications; and
provide the set of reference signals to the one or more RUs in a respective one of the plurality of RU clusters associated with the respective one of the plurality of BEAMIDs to thereby enable the link quality measurement by the respective set of UE in the respective one of the plurality of RU clusters.

10. A method for optimizing a remote unit (RU) cluster(s) in a wireless communications system (WCS), comprising:
processing a link quality measurement collected by a respective set of user equipment (UE) in each of a plurality of RU clusters with respect to one or more RUs in the respective one of the plurality of RU clusters;
determining, based on the processed link quality measurement, whether it is necessary to optimize any of the plurality of RU clusters; and
optimizing one or more of the plurality of RU clusters in response to determining that it is necessary to optimize the one or more of the plurality of RU clusters.

11. The method of claim 10, further comprising:
receiving a plurality of downlink communication signals each corresponding to a respective one of a plurality of BEAMIDs;
forwarding each of the plurality of downlink communication signals to the one or more RUs in a respective one of the plurality of RU clusters associated with the respective one of the plurality of BEAMIDs;
receiving one or more uplink communication signals respectively from the one or more RUs in each of the plurality of RU clusters; and
combining the one or more uplink communication signals into a respective one of a plurality of summed uplink communication signals corresponding to the respective one of the plurality of BEAMIDs associated with the respective one of the plurality of RU clusters.

12. The method of claim 11, further comprising:
determining that the link quality measurement collected by the respective set of UE in a respective one of the plurality of RU clusters with respect to any of the one or more RUs in the respective one of the plurality of RU clusters is below a muting threshold; and
optimizing the respective one of the plurality of RU clusters by stopping the forwarding of the respective one of the plurality of downlink communication signals to the determined one of the one or more RUs.

13. The method of claim 12, further comprising:
determining that the link quality measurement collected by the respective set of UE in the respective one of the plurality of RU clusters with respect to any of the one or more RUs in the respective one of the plurality of RU clusters changes from being below the muting threshold to being above an unmuting threshold higher than the muting threshold; and
optimizing the respective one of the plurality of RU clusters by resuming the forwarding of the respective one of the plurality of downlink communication signals to the determined one of the one or more RUs.

14. The method of claim 12, further comprising optimizing the respective one of the plurality of RU clusters by re-clustering the determined one of the one or more RUs to a different one of the plurality of RU clusters in response to stopping the forwarding of the respective one of the plurality of downlink communication signals to the determined one of the one or more RUs for a predefined time limit.

15. The method of claim 11, further comprising:
determining that the link quality measurement collected by the respective set of UE in a respective one of the plurality of RU clusters with respect to any of the one or more RUs in the respective one of the plurality of RU clusters is below a non-combining threshold; and
optimizing the respective one of the plurality of RU clusters by stopping the combining of a respective one of the one or more uplink communication signals received from the determined one of the one or more RUs into the respective one of the plurality of summed uplink communication signals.

16. The method of claim 15, further comprising:
determining that the link quality measurement collected by the respective set of UE in the respective one of the plurality of RU clusters with respect to any of the one or more RUs in the respective one of the plurality of RU clusters changes from being below the non-combining threshold to being above a combining threshold higher than the non-combining threshold; and
optimizing the respective one of the plurality of RU clusters by resuming the combining the respective one of the one or more uplink communication signals received from the determined one of the one or more RUs into the respective one of the plurality of summed uplink communication signals.

17. The method of claim 15, further comprising optimizing the respective one of the plurality of RU clusters by re-clustering the determined one of the one or more RUs to a different one of the plurality of RU clusters in response to stopping the combining of the respective one of the one or more uplink communication signals received from the determined one of the one or more RUs into the respective one of the plurality of summed uplink communication signals for a predefined time limit.

18. The method of claim 10, further comprising:
determining a set of reference signal identifications for each of the plurality of BEAMIDs;
generating a set of reference signals each corresponding to a respective one of the set of reference signal identifications; and
providing the set of reference signals to the one or more RUs in a respective one of the plurality of RU clusters associated with the respective one of the plurality of BEAMIDs to thereby enable the link quality measurement by the respective set of UE in the respective one of the plurality of RU clusters.

19. A wireless communications system (WCS), comprising:
a centralized services node coupled to a service node; and
an open radio access network (O-RAN) subsystem comprising:
a distribution unit coupled to the centralized services node; and
a remote unit (RU) control circuit coupled to the distribution unit and comprising:
a plurality of RU interfaces each coupled to one or more RUs in a respective one of a plurality of RU clusters associated with a respective one of a plurality of beam identifications (BEAMIDs), wherein the one or more RUs in each of the plurality of RU clusters are configured to communicate with a respective set of user equipment (UE) based on the respective one of the plurality of BEAMIDs; and
a processing circuit coupled to the plurality of RU interfaces and configured to:
process a link quality measurement collected by the respective set of UE in each of the plurality of RU clusters with respect to the one or more RUs in the respective one of the plurality of RU clusters;
determine, based on the processed link quality measurement, whether it is necessary to optimize any of the plurality of RU clusters; and
optimize one or more of the plurality of RU clusters in response to determining that it is necessary to optimize the one or more of the plurality of RU clusters.

20. The WCS of claim 19, wherein the processing circuit is further configured to:
receive a plurality of downlink communication signals each corresponding to a respective one of the plurality of BEAMIDs;
forward each of the plurality of downlink communication signals to the one or more RUs in a respective one of the plurality of RU clusters associated with the respective one of the plurality of BEAMIDs;
receive one or more uplink communication signals respectively from the one or more RUs in each of the plurality of RU clusters; and
combine the one or more uplink communication signals into a respective one of a plurality of summed uplink communication signals corresponding to the respective one of the plurality of BEAMIDs associated with the respective one of the plurality of RU clusters.

21. The WCS of claim 20, wherein each of the one or more RUs in each of the plurality of RU clusters comprises:
a signal processing circuit configured to:
receive a respective one of the plurality of downlink communication signals associated with the respective one of the plurality of BEAMIDs corresponding to the respective one of the plurality of RU clusters; and
provide a respective one of the one or more uplink communication signals to the processing circuit in the RU control circuit;
a beamformer circuit configured to process the respective one of the plurality of downlink communication signals to generate different sets of beamforming signals associated with the respective one of the plurality of BEAMIDs; and
an antenna array configured to simultaneously radiate the different sets of beamforming signals to thereby form one or more respective RF beams in the respective one of the plurality of RU clusters.

22. The WCS of claim 21, wherein:
the processing circuit in the RU control circuit is further configured to:
determine a set of reference signal identifications for each of the plurality of BEAMIDs;
generate a set of reference signals each corresponding to a respective one of the set of reference signal identifications; and
provide the set of reference signals to the one or more RUs in a respective one of the plurality of RU clusters associated with the respective one of the plurality of BEAMIDs to thereby enable the link quality measurement by the respective set of UE in the respective one of the plurality of RU clusters; and
the signal processing circuit is further configured to process the respective one of the plurality of downlink communication signals to include a respective one of the set of reference signals.

23. The WCS of claim 19, wherein the one or more RUs in each of the plurality of RU clusters is coupled to the RU control circuit via an optical fiber-based communications medium.
